(19) United States
(12) Patent Application Publication
(10) Pub. No.: US 2007/0271040 A1
(43) Pub. Date: Nov. 22, 2007

(54) Method for seismic migration in anisotropic media with constrained explicit operators

(76) Inventor: Jiaxiang Ren, Katy, TX (US)

Correspondence Address: E. Eugene Thigpen;Petroleum Geo-Services, Inc., P.O. Box 42805, Houston, TX, 77242-2805, US

(21) Appl. No.: 11/438,173

(22) Filed: May 22, 2006

(51) Int. Cl. G06F 19/00

(52) U.S. Cl. 702/14; 702/1; 702/189

(57) ABSTRACT

Explicit constrained depth extrapolation operators are constructed with variable operator lengths depending on maximum phase angles, accuracy condition, anisotropy parameters, and wavenumber. Operator tables are constructed using the explicit depth extrapolation operator having the smallest operator length satisfying the accuracy condition at the maximum phase angles for each of a plurality of anisotropy parameters and a plurality of wavenumbers. Depth migration is performed using the explicit constrained depth extrapolation operator at a depth having the smallest operator length from the operator tables for the wavenumber.

### CROSS-REFERENCES TO RELATED APPLICATIONS

Not Applicable

### FEDERALLY SPONSORED RESEARCH OR DEVELOPMENT

Not Applicable

### SEQUENCE LISTING, TABLE, OR COMPUTER LISTING

Not Applicable

### BACKGROUND OF THE INVENTION

1. Field of the Invention

This invention relates generally to the field of geophysical prospecting. More particularly, the invention relates to the field of seismic data processing. Specifically, the invention relates to seismic migration in anisotropic media.

2. Description of the Related Art

The use of three-dimensional (3D) seismic methods has resulted in increased drilling success in the oil and gas industry. However, 3D seismic methods are computationally expensive. A crucial point in processing 3D seismic data is the migration step, both because of its 3D nature and the computational cost involved. Seismic migration is the process of constructing the reflector surfaces defining the subterranean earth layers of interest from the recorded seismic data. Thus, the process of migration provides an image of the earth in depth or time. It is intended to account for both positioning (kinematic) and amplitude (dynamic) effects associated with the transmission and reflection of seismic energy from seismic sources to seismic receivers.

Seismic depth migration has traditionally been performed through the application of Kirchhoff methods. However, because of recent advances in computing hardware and improvements in the design of efficient extrapolators, methods that are based on solutions of the one-way wave equation are becoming increasingly popular. Downward wave extrapolation results in a wavefield that is an approximation to the one that would have been recorded if both sources and receivers had been located at a depth z. Downward extrapolation of the seismic wavefield is a key element of wave equation based migrations because it determines the image quality and computational cost.

Although vertical variations in velocity are the most common, lateral variations are also encountered. These velocity variations arise from several causes, including differential compaction of the earth layers, uplift on the flanks of salt diapers, and variation in depositional dynamics between proximal (shaly) and distal (sandy to carbonaceous) shelf locations. Also, many of the subterranean formations encountered in geophysical prospecting constitute anisotropic media. As described by Leon Thomsen, in his 1986 article, “Weak elastic anisotropy”, Geophysics, Vol. 51, No. 10, October, p. 1954-1966, anisotropy in sedimentary sequences is caused by the following main factors: intrinsic anisotropy due to preferred orientation of anisotropic minerals or the shapes of isotropic minerals; thin bedding of isotropic layers on a scale small compared to the wavelength; and vertical or dipping fractures or microcracks. In particular, many formations can be described as vertical transverse isotropic (VTI) media, or, as it is more commonly referred to, transversely isotropic media with a vertical axis of symmetry.

Pre-stack depth migration (PSDM) utilizing a wave equation approach naturally handles multi-arrivals, is not limited by the high frequency assumption of Kirchhoff based PSDM and therefore can produce higher quality images in areas of complex geology. Also, it has been shown that anisotropy, commonly encountered in petroleum exploration, affects image focusing and positioning. Therefore incorporating anisotropy in wave equation PSDM will produce a superior image.

Wave equation migration in laterally varying VTI media has been studied previously. Several methods have been proposed based on utilizing different operators for the wavefield extrapolation. The following are a few examples which will be briefly described here.

Ristow, D. and Ruhl, T., in their 1997 article, “Migration in transversely isotropic media using implicit operators”, 67th Ann. Internat. Mtg., Soc. of Expl. Geophys., p. 1699-1702, describe a two-dimensional (2D) implicit finite-difference method for depth migration. A sequence of cascaded downward continuation operators are modified from Muir-Claerbout operators for the isotropic case, with optimized finite-difference coefficients. The Ristow and Ruhl (1997) method could be extended to three-dimensional (3D) implicit finite-difference depth migration by inline and crossline splitting of the wavefield extrapolation, but this splitting introduces phase errors that require complex extra steps to correct.

Le Rousseau, J. H., in his 1997 article, “Depth migration in heterogeneous, transversely isotropic media with the phase-shift-plus-interpolation method”, 67th Ann. Internat. Mtg., Soc. of Expl. Geophys., p. 1703-1706, describes an adaptation of the phase-shift-plus-interpolation (PSPI) method to transversely isotropic (TI) media. The 3D case for VTI media is derived in terms of the Christoffel equation form of the wave equation and then modified in the 2D case for TI media. The Le Rousseau (1997) PSPI approach is computationally intensive because many reference wavefields need to be formed for different reference velocities and anisotropy parameters.

Zhang, J., Verschuur, D. J. and Wapenaar, C. P. A., in their 2001 article, “Depth migration of shot records in heterogeneous, transversely isotropic media using optimum explicit operators”, Geophys. Prosp., vol. 49, p. 287-299, describe a 2D explicit finite-difference method for depth migration in transversely isotropic media. As an alternative to PSPI, explicit spatial convolution operators are used to incorporate anisotropy into downward continuation by recursive extrapolation.

Helgesen, H., Arntsen, B. and Rosten, T., in their 2003 article, “Wave-equation-based prestack depth migration of converted wave data in TIV media”, 73rd Ann. Internat. Mtg., Soc. of Expl. Geophys., p. 953-956, expand upon this 2D explicit finite-difference approach. Wavefield extrapolation is done separately for the data and source wavefields and an image is obtained by cross-correlation of the two extrapolated wavefields. Both the Zhang et al. (2001) and Helgesen et al. (2003) explicit finite-difference methods are expensive to implement in 3D, due to the large operator size required.

Baumstein, A. and Anderson, J., in their 2003 article, “Wavefield extrapolation in laterally varying VTI media”, 73rd Ann. Internat. Mtg., Soc. of Expl. Geophys., p. 945-948, describe a combination of the PSPI algorithm with an explicit finite-difference correction operator. The correction operator is designed to account for laterally varying anisotropy and makes it easier to control evanescent waves. This Baumstein and Andersonet (2003) hybrid approach offers a partial solution to the cost problem by using a shorter correction operator.

All of the methods discussed above are, however, still computationally expensive. One approach to decreasing the cost of wave equation extrapolation is the design and utilization of constrained operators. The following are examples of constrained operators for the isotropic media case.

Mittet, R., in his 2002 article, “Explicit 3D depth migration with a constrained operator”, 72nd Ann. Internat. Mtg., Soc. Expl. Geophys., Expanded Abstracts, p. 1148-1151, discloses a constrained explicit operator method for isotropic media which is a modification of previous spatial convolutional finite-difference operator approaches to make the scheme more computationally efficient. The number of independent operator coefficients is constrained to reduce the number of computer floating point operations required, thus increasing computer efficiency. The innermost coefficients in the core area of the extrapolation operator are computed in a standard fashion. The remaining outermost coefficients in the operator, related to very high dip and evanescent wave propagation, change only as a function of radius and are constant within radial intervals.

Ren, J., Gerrard, C., McClean, J. and Orlovich, M., in their 2004 article, “An efficient 3D depth migration with explicit finite-difference operators”, 66th Mtg., Eur. Assn. Geosci. Eng., G050, expand upon the Mittet (2002) constrained operator method. Operator lengths and extrapolation step sizes are dynamically selected based on the wavenumber of the wave components being migrated. A phase-shifted linear interpolation improves the accuracy over the linear interpolation typically used for implicit finite-difference migration methods.

Thus, a need exists for an explicit depth extrapolation method for 3D seismic migration for anisotropic media that is more computationally efficient.

### BRIEF SUMMARY OF THE INVENTION

The invention is a method for P-wave seismic migration in anisotropic media with constrained explicit operators. Explicit constrained depth extrapolation operators are constructed with variable operator lengths depending on maximum phase angles, accuracy condition, anisotropy parameters, and wavenumber. Operator tables are constructed using the explicit depth extrapolation operator having the smallest operator length satisfying the accuracy condition at the maximum phase angles for each of a plurality of anisotropy parameters and a plurality of wavenumbers (frequency divided by velocity). Depth migration is performed using the explicit constrained depth extrapolation operator at a depth having the smallest operator length from the operator tables for the wavenumber.

### BRIEF DESCRIPTION OF THE DRAWINGS

The invention and its advantages may be more easily understood by reference to the following detailed description and the attached drawings, in which:

FIG. 1 is a plan view of the coefficient layout of a constrained operator;

FIG. 2 is a flowchart illustrating the processing steps of an embodiment of the method of the invention for constructing explicit constrained depth extrapolation operators with dynamically variable operator length;

FIG. 3A is an vertical slice of image from a North Sea field data set, obtained by applying the anisotropic explicit PSDM method of the invention;

FIG. 3B is the image corresponding to that in FIG. 3A, obtained by applying a method equivalent to the invention, but with velocity derived under an isotropic medium assumption and with no anisotropy parameters;

FIG. 3C is the image corresponding to that in FIG. 3A, obtained by applying anisotropic Kirchhoff PSDM with the same input velocity and anisotropy parameters as those used for FIG. 3A; and

FIG. 3D is the image corresponding to that in FIG. 3A, obtained by applying isotropic Kirchhoff PSDM with the same input velocity as that for FIG. 3B.

While the invention will be described in connection with its preferred embodiments, it will be understood that the invention is not limited to these. On the contrary, the invention is intended to cover all alternatives, modifications, and equivalents that may be included within the scope of the invention, as defined by the appended claims.

### DETAILED DESCRIPTION OF THE INVENTION

The method of the invention is an efficient method for 3D wave equation prestack depth migration for P-waves in laterally varying VTI media. The method accurately handles large lateral variations in anisotropy parameters as well as vertical velocity. The method performs wavefield extrapolation using a modification of a constrained, explicit finite-difference operator originally proposed for isotropic media. Wavefield extrapolation is performed by convolving wavefield and the variable constrained operator with image points. The constrained operator has a reduced number of independent coefficients, leading to improved migration efficiency, whilst retaining accuracy and flexibility for different maximum propagation angles and grid intervals in the inline and crossline directions. An optimization process for the operator design ensures that a large number of well-behaved operators can be quickly designed, for different combinations of vertical velocity and anisotropy parameters. A table of the constrained operators with variable length is constructed by optimization for pre-selected ranges of vertical velocity, anisotropy parameters, and wavenumber.

The invention is a method for seismic wavefield extrapolation for use in 3D explicit finite difference depth migration. In one embodiment, the invention utilizes variable extrapolation step size during each extrapolation step of the depth migration. The variable extrapolation step size is determined dynamically by requiring the wavenumber of the wave component being migrated to satisfy the aliasing condition. The invention utilizes variable extrapolation step size in order to maximize the extrapolation interval during each extrapolation step and thus reduce the total number of extrapolation steps required, thereby reducing the overall computational cost of depth migration.

In another embodiment, the invention utilizes explicit constrained finite-difference operators. Downward extrapolation of a seismic wavefield is the key element of wave equation based migration because the extrapolation step determines the image quality and computational cost.

The invention utilizes Mittet's constrained operator to overcome the numerical anisotropy problem and to keep the computational cost low, comparable to the Hale-McClellan scheme. Use of Mittet's constrained operator benefits migration cost and image quality by providing a reduced number of independent coefficients. The use also provides flexibility that allows for different phase angles and grid intervals in the in-line and cross-line directions.

In another embodiment the invention utilizes variable operator lengths for the extrapolation operators. The variable extrapolation operator length is determined dynamically by the wavenumber of the wave component being migrated. The invention utilizes dynamically variable operator lengths in order to minimize the size of the extrapolation operator and thus reduce the computational cost for extrapolation, thereby further reducing the overall computational cost of depth migration.

To illustrate the method of the invention, seismic wavefield extrapolation for use in 3D explicit finite difference depth migration is described. Downward wavefield extrapolation transforms a seismic wavefield P(ω, x, y, z) at lateral location x, y and depth level z to the seismic wavefield P(ω, x, y, z+Δz) at depth level z+Δz by convolving P(ω, x, y, z) with an extrapolation operator w(k₁₀₇ (x, y), x, y, Δz). The local wavenumber k_{ω}(x, y) is used to handle lateral heterogeneity. The seismic wavefield P(ω, x, y, z) is in the space-frequency domain, having been transformed from the space-time domain, if necessary, by a temporal Fourier transform. Here, x and y are the horizontal spatial coordinates, typically in the in-line and cross-line directions, respectively, of the seismic survey that collected the data. The spatial interval Δz is an extrapolation step size in the vertical z-coordinate direction, where depth z is measured positive downwards. The transformation in explicit depth extrapolation can be expressed in the space-frequency domain by a two-dimensional spatial convolution along the horizontal x- and y-directions, as given in general by:

$$\begin{matrix}P ( ω , x , y , z + Δ z ) = w ( {k}_{ω} , x , y , Δ z ) * P ( ω , x , y , z ) \\ = \int \int w ( {k}_{ω} , {x}^{′} , {y}^{′} , Δ z ) \\ P ( ω , x - {x}^{ ′} , y - {y}^{ ′} , z ) ⅆ {x}^{ ′} ⅆ {y}^{ ′} .\end{matrix} \qquad ( 1 )$$

(1)
The extrapolation given in Equation (1) is applied recursively downward through all extrapolation step sizes Δz to reach all depth levels z of interest.

In the case of isotropic media, the local wavenumber k_{ω}=k_{ω}(x, y) is simply defined by:

$${k}_{ω} ( x , y ) = \frac{ω}{{V}_{P} ( x , y )} \qquad ( 2 )$$

(2)
where ω=2πf is the angular frequency for frequency f and V_{P}=V_{P}(x, y) is the P-wave velocity in the local medium at the lateral location (x, y). The vertical wavenumber k_{z} is then given by:

$${k}_{z} = \sqrt{{k}_{ω}^{2} - ( {k}_{x}^{2} + {k}_{y}^{2} )} = \sqrt{{( \frac{ω}{{V}_{P}} )}^{2} - ( {k}_{x}^{2} + {k}_{y}^{2} )} , \qquad ( 3 )$$

(3)
where kₓ and k_{y} are the horizontal wavenumber components in the x- and y-directions, respectively.

For the more general case of anisotropic media, such as VTI media, the vertical wavenumber k_{z} can now be given by:

$${k}_{z} = \sqrt{{k}_{ω}^{2} ( θ ) - ( {k}_{x}^{2} + {k}_{y}^{2} )} = \sqrt{{( \frac{ω}{{V}_{P} ( θ )} )}^{2} - ( {k}_{x}^{2} + {k}_{y}^{2} )} , \qquad ( 4 )$$

(4)
where the P-wave velocity V_{P}(θ) and the local wavenumber

$${k}_{ω} ( θ ) = \frac{ω}{{V}_{P} ( θ )} \qquad ( 5 )$$

(5)
now depend upon the phase angle, θ. The phase angle is the angle between the normal to the wave front and the vertical direction, and is also often called the dip angle. This angle dependence of k_{ω}(θ) in Equation (4) is caused by the angle dependence of the P-wave velocity V_{P}(θ), as shown in Equation (5).

Under the assumption that S-wave velocity is much smaller than the P-wave velocity, V_{P}(θ) has the following expression:

$${V}_{P} ( θ ) = {V}_{P 0} \sqrt{\frac{1}{2} ( 1 + 2 ɛ {sin}^{2} ( θ ) ) + \frac{1}{2} \sqrt{( ( 1 + 2 ɛ {sin}^{2} ( θ ) ) - 8 ( ɛ - δ ) {sin}^{2} ( θ ) {cos}^{2} ( θ ) )}} \qquad ( 6 )$$

(6)
where V_{P0} is the vertical P-wave velocity, V_{P0}=V_{P}(0), and ε and δ are the Thomsen anisotropy parameters introduced in Thomsen (1986), discussed above.

The Thomsen anisotropy parameters ε and δ are defined in terms of the elastic modulus tensor Cᵢⱼ, as represented in the Voigt representation, which gives the linearly dependence of stress upon strain for elastic media. Thus, the parameters are given by:

$$\begin{matrix}ɛ = \frac{{C}_{11} - {C}_{33}}{2 {C}_{33}} \\ and & ( 7 ) \\ δ = \frac{{( {C}_{13} + {C}_{44} )}^{2} - {( {C}_{33} - {C}_{44} )}^{2}}{2 {C}_{33} ( {C}_{33} - {C}_{44} )} . & ( 8 )\end{matrix}$$

The first Thomsen anisotropy parameter ε may also be defined in terms of the horizontal P-wave velocity V_{P}(90), for phase angle θ=90° and the vertical P-wave velocity V_{P}(0), for phase angle θ=0°. This alternative representation is given by:

$$ɛ = \frac{{V}_{P}^{2} ( 90 ) - {V}_{P}^{2} ( 0 )}{2 {V}_{P}^{2} ( 0 )} . \qquad ( 9 )$$

Equations (7) and (9) show that the Thomsen anisotropy parameter ε represents the fractional difference between the vertical P-wave velocity, through C₃₃ or V_{P}(0), and the horizontal P-wave velocity, through C₁₁ or V_{P}(90), and corresponds to an intuitive definition of the anisotropy of rock media. As Equation (8) shows, the Thomsen anisotropy parameter δ is independent of horizontal P-wave velocity, through C₁₁, but influences vertical P- and S-wave velocities. Thus, the Thomsen anisotropy parameter δ controls anisotropy for near-vertical angles of wave propagation, while the Thomsen anisotropy parameter E controls anisotropy for near-horizontal angles of wave propagation.

With the velocity definition in Equation (6), the vertical wavenumber k_{z} for VTI media can now be expressed as

$$\begin{matrix}\begin{matrix}{k}_{z} = \sqrt{{( \frac{ω}{{V}_{P 0}} )}^{2} - \frac{1 + 2 δ}{1 - 2 ( ɛ - δ ) \frac{( {k}_{x}^{2} + {k}_{y}^{2} )}{{( ω / {V}_{P 0} )}^{2}}} ( {k}_{x}^{2} + {k}_{y}^{2} )} \\ = \sqrt{{k}_{ω 0}^{2} - \frac{1 + 2 δ}{1 - 2 ( ɛ - δ ) \frac{( {k}_{x}^{2} + {k}_{y}^{2} )}{{k}_{ω 0}^{2}}} ( {k}_{x}^{2} + {k}_{y}^{2} )} ,\end{matrix} \\ where & ( 10 ) \\ {k}_{ω 0} = \frac{ω}{{V}_{P 0}} & ( 11 )\end{matrix}$$

is the wavenumber corresponding to the vertical P-wave velocity V_{P0}. Thereafter, k_{ω0} will be referred to as the wavenumber for shortness and convenience.

A discrete version of Equation (1) is needed for computer implementation. Let i, j, l, and m be integers and let Δx and Δy be step sizes (grid intervals) in the x- and y-directions, respectively. Then, lateral locations can be defined discretely by xᵢ=i·Δx, xₗ=l·Δx, yⱼ=j·Δy, and yₘ=m·Δy. For further convenience, lateral spatial differences will be shortened to the representation xᵢ₋₁=xᵢ−xₗ and yⱼ₋ₘ=yⱼ−yₘ. Discrete downward extrapolation transforms a discrete representation of the wavefields P(ω, xₗ, yₘ, z) at depth level z to the wavefield P(ω, xᵢ, yⱼ, z+Δz) at depth level z+Δz, by convolving with a discrete extrapolation operator w(k₁₀₇ (xᵢ, yⱼ), xₗ, yₘ, Δz).

Thus, as in the second equality in Equation (1), a discrete version of explicit depth extrapolation would be expressed in general terms by:

$$P ( ω , {x}_{i} , {y}_{j} , z + Δ z ) = {\sum }_{l = - L}^{L} {\sum }_{m = - M}^{M} w ( {k}_{ω} ( {x}_{i} , {y}_{j} ) , {x}_{i} , {y}_{m} , Δ z ) P ( ω , {x}_{i - l} , {y}_{j - m} , z ) , \qquad ( 12 )$$

where L and M are called the half-lengths of the operator w in the x- and y-directions, respectively. For VTI media, the discrete extrapolation operator w(k_{ω}, x, y, Δz) in Equation (12) can be replaced by the anisotropic discrete extrapolation operator:
w=w(ε^{ij}, δ^{ij}, k_{ω0}^{ij}, x₇, yₘ, Δz) (13)
where ε^{ij}=ε(xᵢ, yⱼ), δ^{ij}=δ(xᵢ, yⱼ), and k_{ω0}^{ij}=k_{ω0}(xᵢ, yⱼ) are the discrete versions of ε, δ, and k_{ω0}.

However, for computational efficiency, the method of the invention preferably utilizes the constrained, explicit finite-difference operators described above in the articles by Mittet (2002) and Ren et al. (2004), rather than a conventional operator such as given in Equation (12). The constrained operator has a reduced number of independent coefficients compared to the conventional explicit operator in Equation (12) and, therefore, can greatly reduce the computational cost.

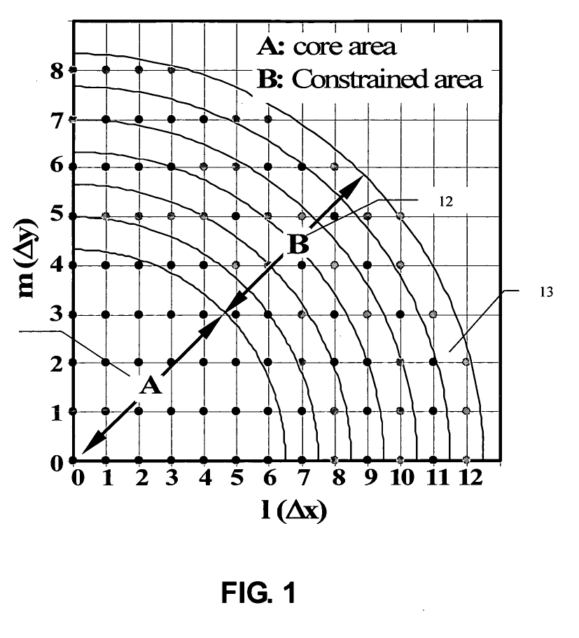

In this embodiment of the invention, the constrained operator assumes a circular symmetry, but divides the operator coefficients into core and constrained areas. FIG. 1 is a plan view of the first-quadrant coefficient layout of an example constrained operator. In the core (innermost) area A, designated by reference numeral 11, the coefficient layout is the same as that for a full operator, as the coefficients retain the full complexity of the standard operator. In the constrained (outer) area B, designated by reference numeral 12, all the coefficients in any one of the dissected, circular bands 13, that is, in a ring with radii (l−½)Δx≦r<(l+½)Δx, are assigned an identical value, resulting in a reduced number of independent coefficients. FIG. 1 shows a constrained operator with the Δy/Δx ratio of 1.5, x-direction half-length of 12, y-direction half-length of 8, and core half-length of 6.

The wavefield extrapolation of the invention can be expressed as:

$$\begin{matrix}P ( ω , {x}_{i} , {y}_{j} , z + Δ z ) = {\sum }_{l , m ∈ A} w ( {ɛ}^{ij} , {δ}^{ij} , {k}_{ω 0}^{ij} , {x}_{l} , {y}_{m} , Δ z ) \\ P ( ω , {x}_{i - 1} , {y}_{j - m} , z ) + \\ {\sum }_{c ∈ B} {w}_{c} ( {ɛ}^{ij} , {δ}^{ij} , {k}_{ω 0}^{ij} , {x}_{l} , {y}_{m} , Δ z ) \\ {\sum }_{l , M ∈ c} P ( ω , {x}_{i - 1} , {y}_{j - m} , z ) ,\end{matrix}$$

where the first sum on the right hand side of Equation (14) is the convolution operation in the core area A, with the coefficients of the operator w varying with the lateral indices (l, m). The second sum on the right hand side of Equation (14) is the simplified convolution operation in the constrained area B, with only one single operator coefficient w_{c} being used throughout each circular band c.

Using the constrained operator reduces the number of independent operator coefficients. By factorizing out the coefficients in a ring in the constrained area B during the convolution, the number of complex multiplication operations is reduced. Because complex multiplication is relatively expensive compared to the remaining complex addition, using the constrained operator improves the extrapolation efficiency, and thus reduces the cost. The extrapolation process is able to handle any lateral heterogeneity, because the operator used is a function of local vertical P-wave velocity, V_{P0}(xᵢ, yⱼ), and local Thomsen anisotropy parameters, ε(xᵢ, yⱼ) and δ(xᵢ, yⱼ).

The size of the two sums in Equation (14) determines the operator length, or size, of the explicit extrapolation operator w, and thus the efficiency of the extrapolation method. In principle, the operator length would be infinite for exactness. In practice, this operator length must be finite for computer implementation. In particular, this operator length should be minimized for increased computer efficiency. In another embodiment of the invention, the operator lengths can be made to depend optimally on the wavenumber k_{ω0}(xᵢ, yⱼ) and the Thomsen anisotropy parameters ε(xᵢ, yⱼ) and δ(xᵢ, yⱼ).

In one embodiment of the invention, the coefficients of the extrapolation operator w are designed to approximate the inverse spatial Fourier transform of the exact extrapolation operator E for explicit depth extrapolation. The exact extrapolation operator E is given in the frequency-wavenumber domain by the phase shift operator:
E(ε, δ, k_{ω0}, kₓ, k_{y}, Δz)=exp(ik_{z}·Δz). (15)
where the vertical wavenumber is given in Equation (10).

The design strategy is to optimize the discrete operator w(ε, δ, k_{ω0}, xₗ, yₘ, Δz) such that its wavenumber-domain response W(ε, δ, k_{ω0}, kₓ, k_{y}, Δz) approximates the exact extrapolation operator E(ε, δ, k_{ω0}, kₓ, k_{y}, Δz) given by Equation (15) closely. The difference between the operators E(ε, δ, k_{ω0}, kₓ, k_{y}, Δz) and W (ε, δ, k_{107 0}, kₓ, k_{y}, Δz) should be a minimum for a given wavenumber k_{ω0}(x, y) and for given Thomsen anisotropy parameters ε and δ. Thus, for each ε, δ, and k_{ω0}, the difference between the operators E(ε, δ, k_{ω0}, kₓ, k_{y}, Δz) and W(ε, δ, k_{ω0}, kₓ, k_{y}, Δz) is minimized in some appropriate norm, represented by ∥ ∥, in the frequency-wavenumber domain:
∥E(ε, δ, k_{ω0}, kₓ, k_{y}, Δz)−W(ε, δ, k_{ω0}, kₓ, k_{y}, Δz)∥=minimum, (16)
over an appropriate range of horizontal wavenumbers kₓ and k_{y}.

In one embodiment of the invention, the optimization is performed on the operator's real and imaginary parts using an L⁸ norm for all wavenumbers kₓ and k_{y} up to the critical wavenumber kᵣ^{c}=(kₓ^{c}, k_{y}^{c}) determined by

$$\frac{{( {k}_{x}^{c} )}^{2}}{{[ ω / {V}_{P} ( {θ}_{x}^{max} ) ]}^{2} {sin}^{2} ( {θ}_{x}^{max} )} + \frac{{( {k}_{y}^{2} )}^{2}}{{[ ω / {V}_{P} ( {θ}_{y}^{max} ) ]}^{2} {sin}^{2} ( {θ}_{y}^{max} )} = 1 , \qquad ( 17 )$$

where θₓ^{max} and θ_{y}^{max} are the maximum phase angles considered in the x- and y-directions, respectively, and V_{P}(θₓ^{max}) and V_{P}(θ_{y}^{max}) are the P-wave velocities at the maximum phase angles θₓ^{max}and θ_{y}^{max}. The velocities can be evaluated with Equation (6). The angles θₓ^{max} and θ_{y}^{max} can also be viewed as the maximum dip angles selected to be accurately imaged in the x- and y-directions, respectively. A Gaussian taper is applied for very high dip and evanescent waves.

Thus Equation (16) becomes:

$$\begin{matrix}{\sum }_{k = ( {k}_{x} , {k}_{y} )} {[ {( {E}_{r} - {W}_{r} )}^{2} + {( {E}_{i} - {W}_{i} )}^{2} ]}^{4} = minimum , & for \vert k \vert \leq \vert {k}_{c} \vert , \\ \vert W \vert < exp [ - {α ( \vert k \vert - \vert {k}_{c} \vert )}^{2} ] , & for \vert k \vert > \vert {k}_{c} \vert ,\end{matrix} \qquad ( 18 )$$

for some small α and the critical wavenumber k_{c} as defined in Equation (17). Here the subscripts r and i denote the real and imaginary parts, respectively, of the operators E and W. Such an operator design algorithm is both stable and efficient. Next, for each Thomsen anisotropy parameter pair ε and δ in a selected range, an operator is designed for each wavenumber k_{ω0}=(ω/V_{P0}).

In one embodiment of the invention, the constrained operator is designed for a sufficient set of wavenumbers k_{ω0} and Thomsen anisotropy parameters ε and δ, which are then utilized to form an operator table. For a given accuracy, the operator length required varies with the wavenumber k_{ω0} and Thomsen anisotropy parameters ε and δ. In another embodiment of the invention, the operator design process designs the shortest operator that satisfies the accuracy based on the wavenumber k_{ω0} and Thomsen anisotropy parameters ε and δ. This measure avoids using unnecessarily long operators by the wavefield extrapolation process and can reduce computational cost.

A standard procedure in the art is to set the operator length to a constant for all wavenumbers k_{ω0} for given Thomsen anisotropy parameters ε and δ. It is well known in the art that when the maximum design propagation (phase) angle is increased, the operator length must also be increased, if the numerical accuracy is to be kept fixed. However, for a given maximum propagation angle and a fixed numerical accuracy, the required operator length varies with k_{ω0} for given Thomsen anisotropy parameters ε and δ. The dependency is such that the operator length must be increased with increased k_{ω0} for given Thomsen anisotropy parameters ε and δ. Thus, the numerical workload of depth extrapolation can be significantly reduced by constructing operator tables with variable operator lengths.

Operator tables with variable operator lengths may be obtained in several ways. In one embodiment of the invention, the operator tables are obtained directly in the operator optimization software. For each wavenumber k_{ω0} and Thomsen anisotropy parameters ε and δ, the strategy is to start with too low a value of the operator length. Then the value of the operator length is increased with a step until proper convergence is achieved. Design and utilization of operator tables with variable operator lengths in the case of explicit operators for migration in isotropic media is discussed, for example, in U.S. patent application Ser. No. 10/668,909, by Mittet, “Method for Seismic Migration using Explicit Depth Extrapolation Operators with Dynamically Variable Operator Length”, filed Sep. 22, 2003, and assigned to the assignee of the present application.

Variable length operator tables require a determination of local wavenumber k_{ω0} as well as the Thomsen anisotropy parameters ε and δ during the wavefield extrapolation. The simplest procedure to determine k_{ω0} is to determine the local vertical velocity at the lateral location (xᵢ, yⱼ) at each depth level z. Explicit depth extrapolation is performed for one frequency ω value at a time. When the angular frequency co and the local vertical velocity V_{P0}(xᵢ, yⱼ) are known, then k_{ω0} is given by Equation (11). Thus, the required extrapolation operator length is known at the location at this depth step Δz. Here, the source of the gain in computer efficiency is apparent. First, for small and intermediate values of frequency ω, high numerical accuracy can be retained with an extrapolation operator with short operator length. Second, in high velocity zones, as, for example, in salt, k_{ω0}(xᵢ, yⱼ) will be small due to the high value for the vertical velocity V_{P0}(xᵢ, yⱼ). Again, high accuracy and high dip wave extrapolation can be performed with relatively short extrapolation operator lengths.

In yet another embodiment of the invention, a variable extrapolation step size Δz is utilized to reduce the number of extrapolations. The variable step size Δz is determined dynamically according to the aliasing condition by the wavenumber.

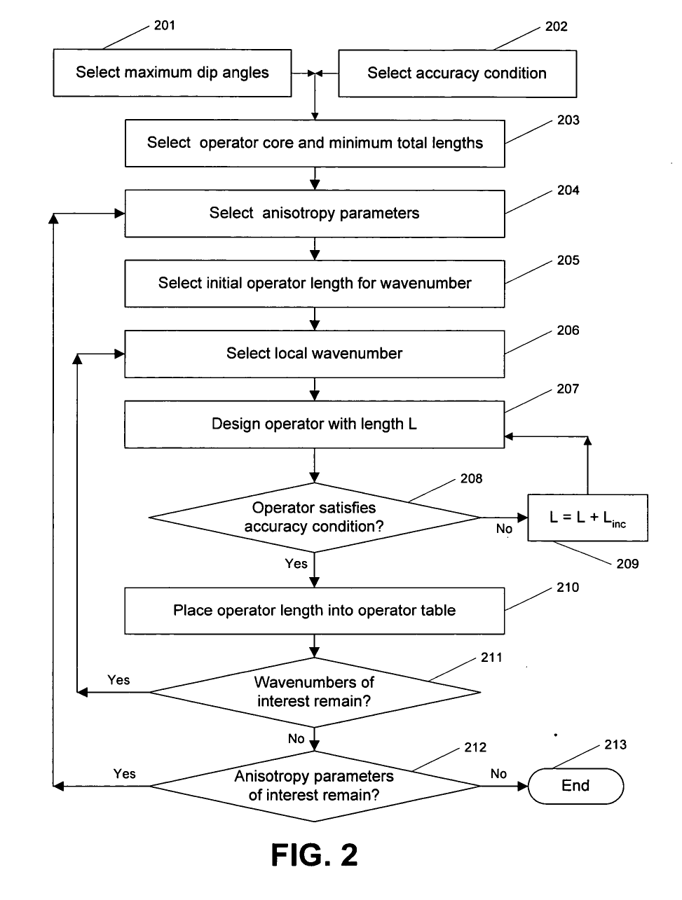

There are several ways to obtain operator tables with variable operator lengths. A particularly efficient embodiment of the method of the invention is to obtain the tables directly in the operator optimization software. For each wavenumber k_{ω0} and Thomsen anisotropy parameters ε and δ, the strategy is to start with too low a value of the operator length. Then the value of the operator length is increased with steps of 1 until proper convergence is achieved. This strategy is illustrated in FIG. 2, which shows a flowchart illustrating the processing steps of a first embodiment of the method of the invention for constructing tables of explicit constrained depth extrapolation operators with dynamically variable operator length.

At step 201, a maximum phase angle or dip angle to be accurately imaged is selected. Alternatively, maximum dip angles to be accurately migrated are selected in both the x-coordinate and y-coordinate directions. Typically, the x-coordinate and y-coordinate directions are the in-line and cross-line directions, respectively, of a seismic survey used to collect seismic data. Alternatively, maximum dip angles in all directions are selected.

At step 202, accuracy conditions are selected for the maximum dip angles selected in step 201. The accuracy conditions are selected to determine if the operator length, which determines the size of the explicit constrained depth extrapolation operators, are sufficiently large. For example, the accuracy conditions could include the requirement that the explicit extrapolation operator satisfy the accuracy condition in the wavenumber passband region given in Equation (18), above. Including this accuracy condition would require calculating cutoff wavenumbers kₓ^{c=}kₓ^{c}(θₓ^{max}) and k_{y}^{c}=k_{y}^{c}(θ_{y}^{max}), as given by Equation (17), to define the passband region. The cutoff wavenumbers depend upon the maximum dip angles θₓ^{max} and θ_{y}^{max}, in the x-coordinate and y-coordinate directions, respectively, selected in step 201.

At step 203, an operator length is selected. For the explicit constrained operator of the invention, given in Equation (14) above, a core length L_{c} and a minimum total length Lₘᵢₙ≧L_{c} must be selected. In addition, a length increment, L_{inc}, for systematically increasing the operator length, is selected. In one embodiment, L_{inc}=1.

At step 204, Thomsen anisotropy parameters ε and δ are selected. The parameters ε and δ are defined above in Equations (7) and (8), respectively.

At step 205, the total operator length L is set as an initial length to the minimum total operator length Lₘᵢₙ selected in step 203. The selection of the total operator length L is preferably done in a systematic manner, for computational efficiency, although systematic selection of the total operator length L is not a requirement of the invention. Nonetheless, for clarity, the method of the invention will be illustrated here in this systematic fashion.

At step 206, a wavenumber k_{ω0} is selected for the given Thomsen anisotropy parameters ε and δ selected in step 204. The selection of the wavenumber k_{ω0} is preferably done in a systematic manner, for computational efficiency, although systematic selection of the wavenumber k_{ω0} is not a requirement of the invention. For example, a range of wavenumbers k_{ω0} can be taken as going from a lowest wavenumber of interest, such as zero, to a highest wavenumber of interest, such as a Nyquist wavenumber. Then, the selection of the wavenumbers k_{ω0} can start with the lowest wavenumber of interest and proceed sequentially to the highest wavenumber of interest.

At step 207, an operator is designed according to the optimization process described above with reference to Equations (17) and (18) or, more generally, Equation (16). The operator is designed with the total operator length L, for the Thomsen anisotropy parameters ε and δ selected in step 204 and the wavenumber k_{ω0} selected in step 206.

At step 208, it is determined if the operator designed in step 207 with the total operator length L satisfies the accuracy conditions selected in step 202 for the maximum dip angles selected in step 201. If the answer is no, the accuracy conditions are not satisfied, then the process continues to step 209 to select another operator length and then return to step 207. If the answer is yes, the accuracy conditions are satisfied, then the process continues to step 210.

At step 209, the current total operator length L is incremented by the length increment, L_{inc}, selected in step 203. Thus, L=L+L_{inc}. Then the process returns to step 207 to design another operator with the increased operator length L.

At step 210, the operator of total operator length L determined in step 207 is placed into an operator table.

At step 211 it is determined if any wavenumbers k_{ω0} of interest remain to be selected in step 206. If the answer is yes, wavenumbers k_{ω0} of interest remain, then the process returns to step 206 to select another wavenumber k_{ω0}. If the answer is no, no wavenumbers k_{ω0} of interest remain, then the process continues to step 212.

At step 212 it is determined if any Thomsen anisotropy parameters ε and δ of interest remain to be selected in step 204. If the answer is yes, Thomsen anisotropy parameters ε and δ of interest remain, then the process returns to step 204 to select another set of parameters. If the answer is no, no Thomsen anisotropy parameters ε and δ of interest remain, then the process continues to step 213.

At step 213, the process ends. A table of explicit constrained depth extrapolation operators for anisotropic media with dynamically variable operator length has been constructed.

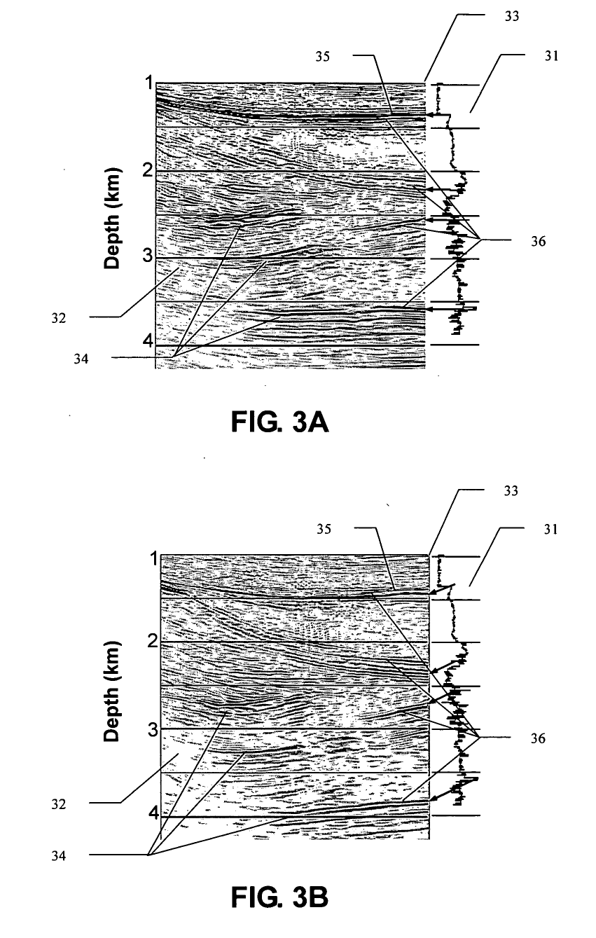

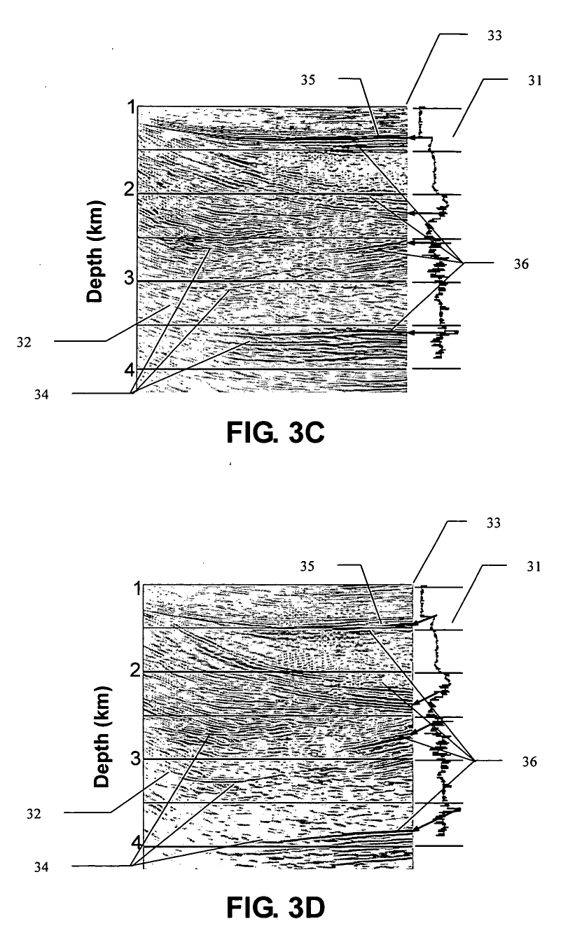

FIG. 3A is a vertical slice of image from a North Sea field data set, obtained by applying the anisotropic explicit PSDM method of the invention.

As an example, an embodiment of the method of the invention is applied to a field data set from the North Sea. FIG. 3A shows a vertical slice of the image obtained by the anisotropic explicit PSDM, the method of the invention, together with a well log 31. The image shown in FIG. 3A covers the area between a salt flank 32 on the left and a well 33 on the right edge, where the well log 31 is placed.

For comparison, FIGS. 3B, 3C, and 3D show the corresponding results obtained from applying isotropic explicit PSDM, anisotropic Kirchhoff PSDM, and isotropic Kirchhoff PSDM, respectively to the image shown in FIG. 3A. FIG. 3B shows the image corresponding to that in FIG. 3A, obtained by applying isotropic explicit PSDM, a method equivalent to the invention, but whose input parameters consist of no anisotropy parameters and only velocity derived under the isotropic medium assumption. FIG. 3C shows the image corresponding to that in FIG. 3A, obtained by applying anisotropic Kirchhoff PSDM with the same input velocity and anisotropy parameters as those used for FIG. 3A. FIG. 3D shows the image corresponding to that in FIG. 3A, obtained by applying isotropic Kirchhoff PSDM with the same input velocity (and no anisotropy parameters) as that for FIG. 3B.

The anisotropic explicit PSDM of the invention produces the best image, as shown in FIG. 3A. Compared with the Kirchhoff PSDM images (FIGS. 3C and 3D), the image in FIG. 3A defines the reflectors 34 around the salt body 32 most clearly. Compared with the isotropic PSDM images (FIGS. 3B and 3D), the anisotropic PSDM of the invention (FIG. 3A) better resolves the top boundary 35 of a chalk layer between depths 1.0 km and 2.5 km below a high anisotropy overburden. By considering the anisotropy (δ) derived from the well tie, the anisotropic explicit PSDM result shown in FIG. 3A also positions the reflectors 36 more correctly.

The method of the invention is an efficient method for 3D wave equation PSDM in laterally varying VTI media. The method of the invention has high efficiency manly due to the reduced number of independent coefficients of the constrained operator used. Anisotropy can be naturally incorporated in the operator, at the operator design stage, while the wavefield extrapolation process is essentially the same as the isotropic case. Therefore, anisotropy has a minimal effect on the algorithm complexity and computational cost compared to other methods. The method can accurately handle strong lateral heterogeneity in the Thomsen anisotropy parameters, ε and δ, as well as vertical velocity, because the operator for wavefield extrapolation is selected based upon local medium parameters at the image point. The optimization algorithm for operator design ensures operator accuracy and handles the challenge of a greatly increased number of operators, due to anisotropy, while maintaining stability.

The constrained operator is accurate and reliable for wavefield extrapolation in explicit finite difference depth migrations. The smaller number of independent coefficients offered by the operator leads to a reduced migration computational cost. Its flexibility to allow for a larger grid interval and shorter operator length in the cross-line direction makes it a useful and efficient method for migrating marine seismic data. The dynamic selection of the operator length and extrapolation step size based on the wavenumber also contributes to the efficiency of the method. The effective number of extrapolation operator coefficients varies dynamically as a function of the maximum ratio of frequency to vertical velocity at a depth level.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents.

1. A method for seismic data processing, comprising:
constructing explicit constrained depth extrapolation operators with variable operator lengths depending on maximum phase angles, accuracy condition, anisotropy parameters, and wavenumber;
constructing operator tables using the explicit depth extrapolation operator having the smallest operator length satisfying the accuracy condition at the maximum phase angles for each of a plurality of anisotropy parameters and a plurality of wavenumbers; and
performing depth migration using the explicit constrained depth extrapolation operator at a depth having the smallest operator length from the operator tables for the wavenumber, providing an image of the earth in depth.

2. The method of claim 1, wherein the maximum phase angles comprise maximum phase angles considered in the x- and y-directions.

3. The method of claim 2, wherein the maximum phase angles comprise maximum dip angles selected to be accurately imaged in the x- and y-directions.

4. The method of claim 1, wherein the accuracy condition comprises:
minimizing, for each of the plurality of anisotropy parameters and the plurality of wavenumbers, the difference between the exact extrapolation operator and the constructed operator in the frequency-wavenumber domain for an appropriate range of horizontal wavenumbers.

5. The method of claim 1, wherein the anisotropy parameters comprise Thomsen anisotropy parameters ε and δ.

6. The method of claim 1, wherein the wavenumber k_{ω0} comprises
$${k}_{ω 0} = \frac{ω}{{V}_{P 0}}$$
where ω is angular frequency and V_{P0} is vertical P-wave velocity.

7. The method of claim 1, wherein the step of constructing operator tables comprises:
selecting a maximum dip angle;
selecting an accuracy condition;
selecting a plurality of anisotropy parameter pairs;
selecting a plurality of wavenumbers; and
performing the following steps for each combination of the plurality of anisotropy parameter pairs and wavenumbers:
designing a plurality of operators for the selected combination of anisotropy parameter pair and wavenumber; and
performing the following steps for each of the plurality of designed operators;
determining if the designed operator satisfies the selected accuracy condition at the selected maximum dip angle at the selected wavenumber and selected anisotropy parameter pair; and
storing the operator length in an operator table.
